(19) United States
(12) Patent Application Publication
(10) Pub. No.: US 2010/0096515 A1
(43) Pub. Date: Apr. 22, 2010

(54) Convertible Display Stand System and Method

(76) Inventors: Joel Hazzard, Osceola, WI (US); Saeb Asamarai, Columbia Heights, MN (US); Ryan Dahl, Inver Grove Heights, MN (US); Peter Segar, Burnsville, MN (US); Jeffrey Randall Mensing, Plymouth, MN (US); Shaun Christopher Lindblad, Lino Lakes, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/614,032

(22) Filed: Nov. 6, 2009

Related U.S. Application Data
(63) Continuation-in-part of application No. 12/249,372, filed on Oct. 10, 2008.
(60) Provisional application No. 60/979,522, filed on Oct. 12, 2007.

(51) Int. Cl. F16M 11/20; F16M 13/00

(52) U.S. Cl. 248/121; 248/207

(57) ABSTRACT

A convertible mounting system for selectively positioning a flat panel display on either a generally horizontal surface or a generally vertical surface. In some embodiments, the convertible mounting system includes a first mount portion and a second mount portion. The first mount portion cooperates with the second mount portion in a first orientation to position a flat panel display on a generally horizontal surface. The first mount portion also cooperates with the second mount portion in a second orientation to position the flat panel display on a generally vertical surface.

### RELATED APPLICATIONS

This application is a continuation in part of U.S. application Ser. No. 12/249,372, titled Convertible Display Stand System and Method, filed Oct. 10, 2008, which itself claims priority to U.S. Provisional Patent Application Ser. No. 60/979,522, filed Oct. 12, 2007, and titled “Convertible Display Stand System and Method,” the contents of each of which are hereby incorporated by reference.

### TECHNICAL FIELD

The invention relates to devices and methods for moveably supporting equipment including, but not limited to, flat panel display screens such as plasma screens and liquid crystal display screens.

### BACKGROUND

Display screens, such as flat panel displays, are used in a variety of situations for both work and leisure. Generally, these displays are provided from the manufacturer with a stand to place the display screen on a horizontal surface such as a desk or table. Unfortunately, many consumers desire to mount a display in an orientation that is not enabled by the stand. Such consumers must purchase additional stands or mounts and consume time and energy removing the old stand and installing the new stand or mount, as well as generate waste with the undesired old stand.

### SUMMARY OF THE INVENTION

Embodiments of the invention include a convertible mounting system for selectively positioning a flat panel display on either a generally horizontal surface or a generally vertical surface. In some embodiments, the convertible mounting system includes a first mount portion and a second mount portion. The first mount portion cooperates with the second mount portion in a first orientation to position a flat panel display on a generally horizontal surface, and the first mount portion cooperates with the second mount portion in a second orientation to position the flat panel display on a generally vertical surface.

In some embodiments a first alignment of the second mount portion in the first orientation is generally orthogonal to a second alignment of the second mount portion in the second orientation. In some embodiments, the first and the second mount portions are removably coupled together. In some embodiments the first and the second mount portions are rotatably engaged. In some embodiments, the first mount portion is rotated approximately 180 degrees with respect to the second mount portion in the first orientation with respect to the second orientation. Further, degrees of motion such as tilt, pan, and/or lift can be provided in either or both of the convertible mounting system orientations. Embodiments of the invention also include methods of making and using such convertible mounting systems.

### BRIEF DESCRIPTION OF THE DRAWINGS

FIG. 1 shows a perspective view of a flat panel display and a convertible mounting system in a first orientation in accordance with an embodiment of the invention.

FIG. 2 shows a perspective view of a flat panel display and a convertible mounting system in a second orientation in accordance with an embodiment of the invention.

FIG. 3 shows a perspective view of a convertible mounting system in a first orientation in accordance with an embodiment of the invention.

FIG. 4 shows a perspective view of a convertible mounting system in a second orientation in accordance with an embodiment of the invention.

FIG. 5(a) shows an exploded perspective view of a first mount portion in accordance with an embodiment of the invention.

FIG. 5(b) shows a rear perspective view of a first mount portion in accordance with an embodiment of the invention.

FIG. 5(c) shows a front perspective view of a first mount portion in accordance with an embodiment of the invention.

FIG. 6(a) shows a perspective view of a second mount portion and base in accordance with an embodiment of the invention.

FIG. 6(b) shows a perspective view of a second mount portion and base in accordance with an embodiment of the invention.

FIG. 6(c) shows a perspective view of a second mount portion, base, and disassembled cover plate in accordance with an embodiment of the invention.

FIG. 6(d) shows a perspective view of a second mount portion, base, and assembled cover plate in accordance with an embodiment of the invention.

FIG. 7(a) shows a convertible mounting system in a first orientation in accordance with an embodiment of the invention.

FIG. 7(b) shows a convertible mounting system in a second orientation in accordance with an embodiment of the invention.

FIG. 8 shows a rear plan schematic view of a flat panel display and convertible mounting system in a second orientation in accordance with an embodiment of the invention.

FIG. 9 shows a side plan schematic view of a flat panel display and convertible mounting system in a second orientation in accordance with an embodiment of the invention.

FIG. 10 shows a perspective view of a flat panel display and a convertible mounting system in a first orientation in accordance with an embodiment of the invention.

FIG. 11 shows a perspective view of a flat panel display and a convertible mounting system in a second orientation in accordance with an embodiment of the invention.

FIG. 12 shows a perspective view of a convertible mounting system in a first orientation in accordance with an embodiment of the invention.

FIG. 13 shows a perspective view of a convertible mounting system in a second orientation in accordance with an embodiment of the invention.

FIG. 14 shows a cross-sectional view of a convertible mounting system in a first orientation in accordance with an embodiment of the invention.

FIG. 15 shows a rear perspective view of a convertible mounting system including a removable cover in accordance with an embodiment of the invention.

FIG. 16 shows a rear view of a convertible mounting system absent a removable cover in accordance with an embodiment of the invention.

FIG. 17 shows a rear perspective view of a convertible mounting system including a tilt stop in accordance with an embodiment of the invention.

FIG. 18 shows a front perspective view of a convertible mounting system including a base in a second orientation in accordance with an embodiment of the invention.

FIG. 19 shows a side perspective view of a flat panel display and a convertible mounting system in a first orientation including a disassembled cover plate in accordance with an embodiment of the invention.

FIG. 20 shows a perspective view of a second mount portion and a base in accordance with an embodiment of the invention.

FIG. 21 shows a perspective view of a second mount portion and a base in accordance with an embodiment of the invention.

FIG. 22 shows a perspective view of a base in a second orientation in accordance with an embodiment of the invention.

FIG. 23 shows a side perspective view of a second mount portion and a base in a second orientation in accordance with an embodiment of the invention.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the invention. Therefore, the following detailed description is not to be taken in a limiting sense, and the scope of the invention is defined by the appended claims and their equivalents.

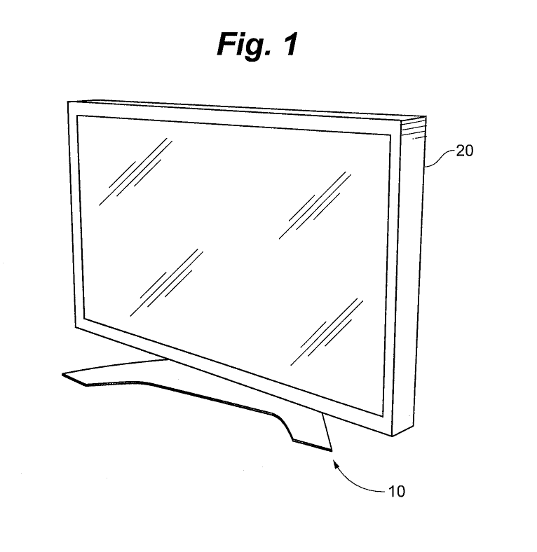

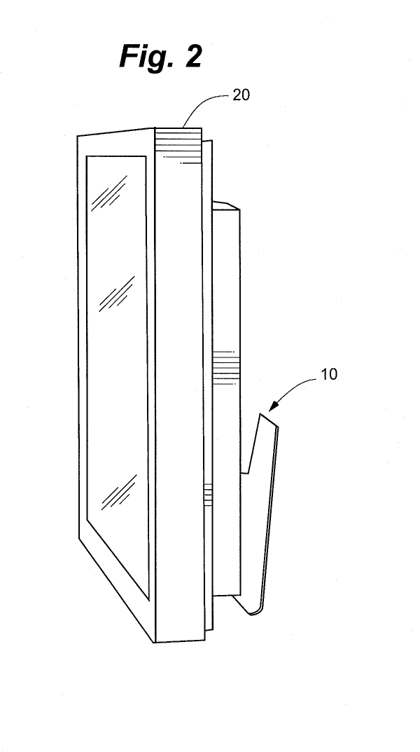

FIGS. 1 and 2 show perspective views of a flat panel display and a convertible mounting system in a first orientation and a second orientation, respectively. The convertible mounting system 10 operates to position a flat panel display 20 on a generally horizontal surface (e.g., desk top, table, floor, ceiling, desk mount via clamp or grommet mounting, etc.) or a generally vertical surface (e.g., wall, wall track mount, pole, column, etc.). The flat panel display 20 includes, but is not limited to, a plasma display, liquid crystal display (LCD), organic light-emitting diode (OLED), or the like. The convertible mounting system 10 may accommodate a wide variety of display sizes and weights.

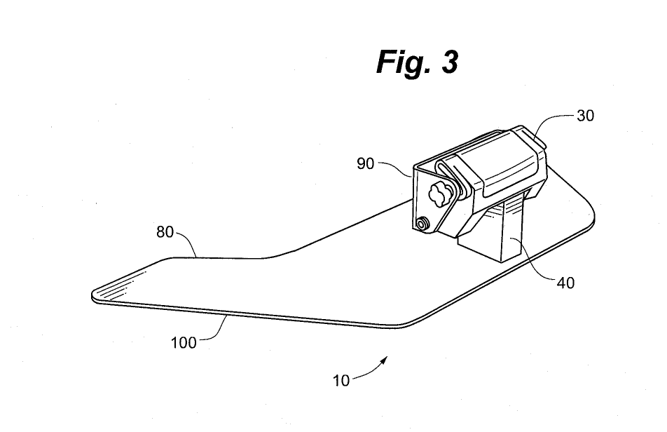

In some embodiments, the invention includes a convertible mounting system 10 for a flat panel display 20. As shown in FIG. 3, the convertible mounting system 10 can include a first mount portion 30 and a second mount portion 40. In some embodiments, as shown in

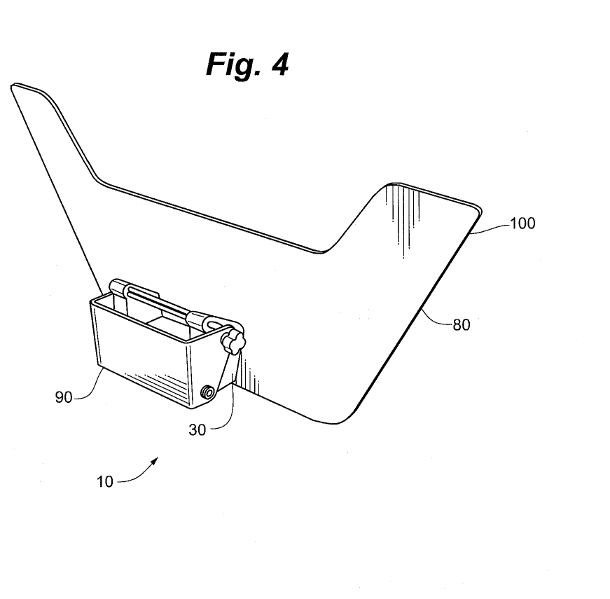

FIG. 3, the first mount portion 30 cooperates with the second mount portion 40 in a first orientation to position a flat panel display 20 on a generally horizontal surface. As shown in FIG. 4, the first mount portion also cooperates with the second mount portion in a second orientation to position the flat panel display on a generally vertical surface. In certain embodiments, the first mount portion is generally orthogonal to the second mount portion in the first orientation with respect to the second orientation. This relative orthogonal relationship is useful for converting between orthogonal surfaces, such as a generally vertical surface and a generally horizontal surface.

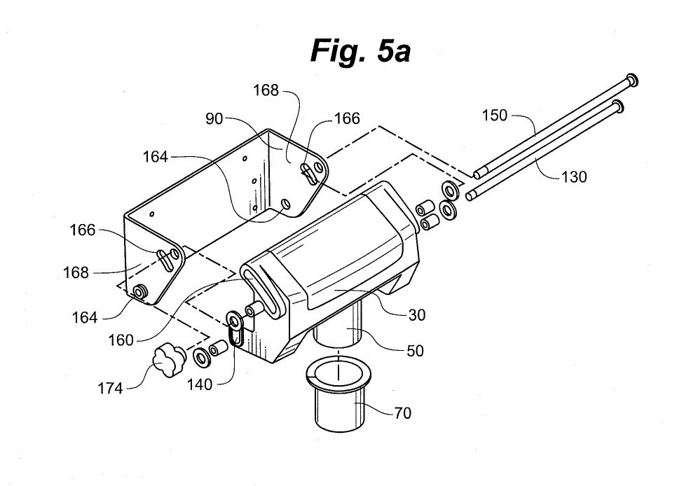

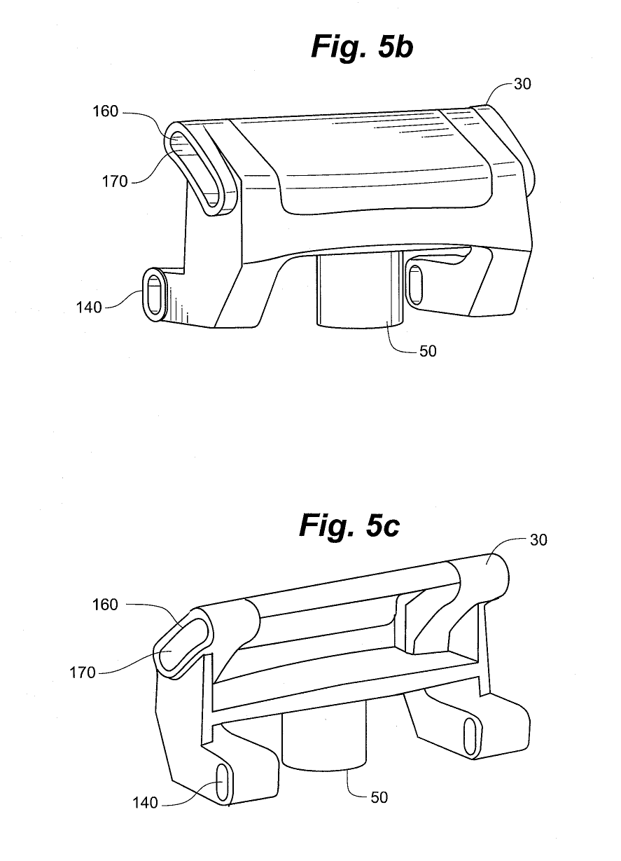

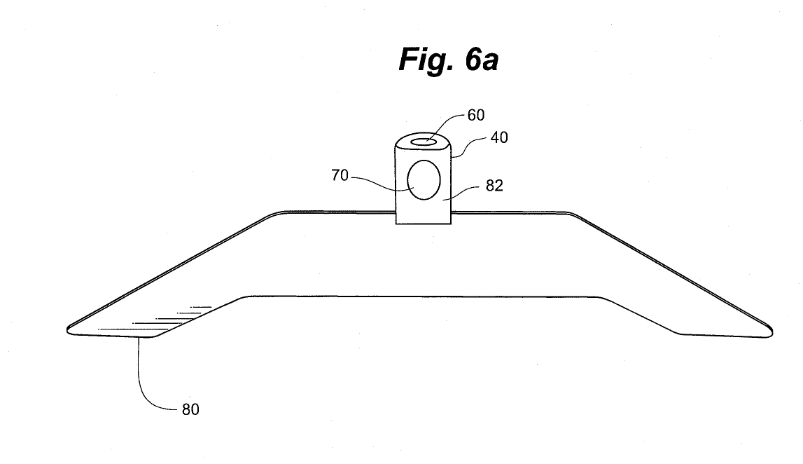

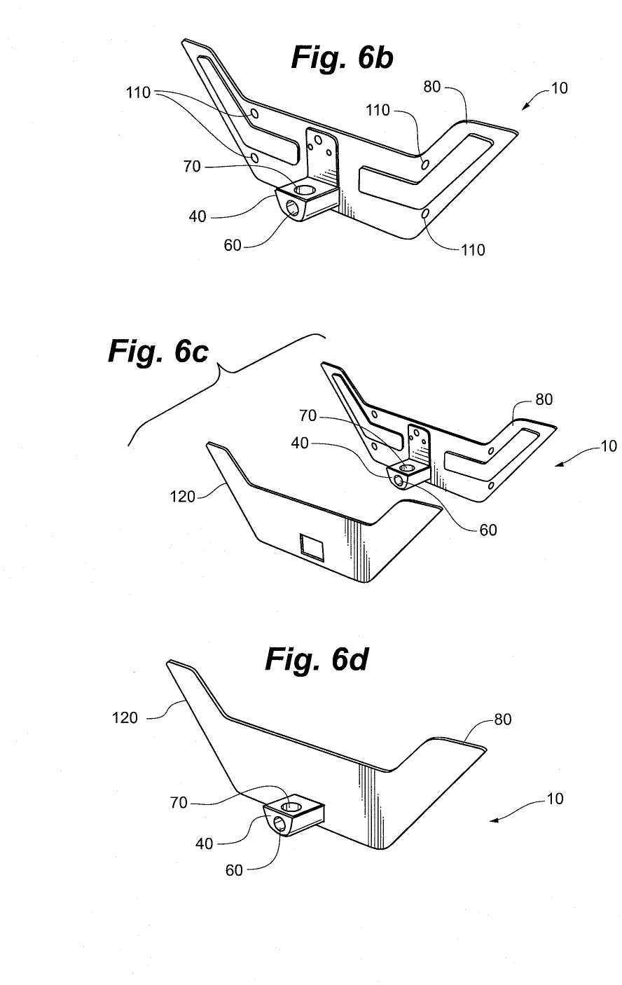

The first and second mount portions can include any structure useful for allowing conversion between a mount useful for positioning a display on a horizontal surface and a mount system useful for positioning a display on a generally vertical surface. In some embodiments, as shown in FIGS. 5(a)-(c), the first mount portion includes a first mount engaging member 50 and, as shown in FIGS. 6(a)-(d), the second mount portion can include a first second mount engaging member 60 and a second second mount engaging member 70 generally orthogonal to the first second mount engaging member. The first mount engaging member is engageable with the first second mount engaging member to provide a mounting system to position a flat panel display on a generally horizontal surface. Further, the first mount engaging member is engageable with the second second mount engaging member to provide a mounting system to position the flat panel display on a generally vertical surface. In such an embodiment, the first mount portion or the second mount portion can be connected to a flat panel display or a base 80, as discussed further below.

As shown in FIGS. 5(a)-(c), the first mount engaging member 50 can include a rigid protrusion extending generally downward when the first mount portion is coupled to the display. In such embodiments, as shown in FIG. 6(a), the second mount portion can include a second mount portion body 82 and the first and second second mount engaging members 60, 70 can include a first protrusion receiving aperture and a second protrusion receiving aperture, respectively, each defined by the second mount portion body. The first protrusion receiving aperture can be placed to receive the rigid protrusion of the first mount portion to position a display on a generally horizontal surface, and the second protrusion receiving aperture can be placed to receive the rigid protrusion to position the display on a generally vertical surface. In some embodiments, the first and second protrusion receiving apertures are generally orthogonal.

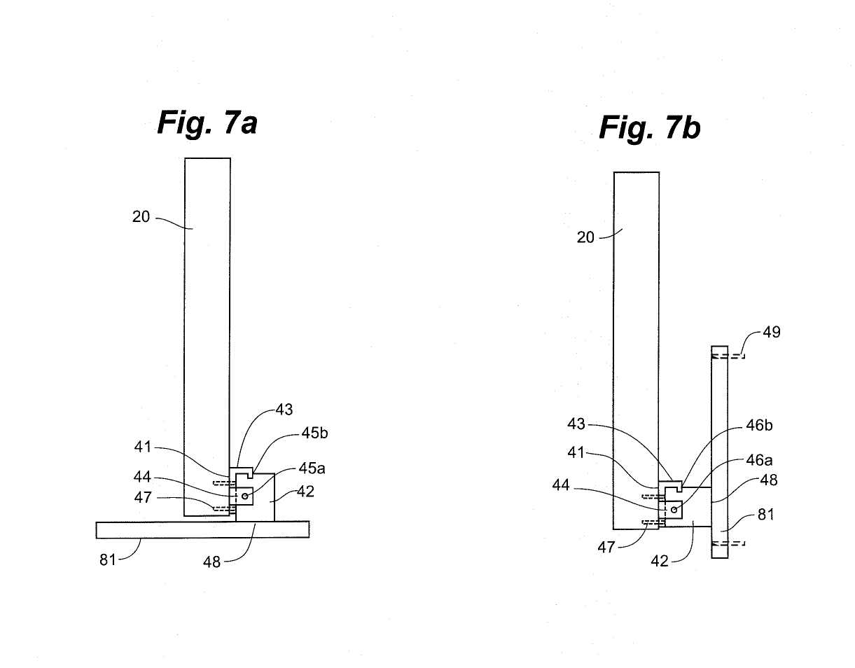

As discussed above, the first and second mount portions can include any structure useful for allowing conversion between a mount useful for positioning a display on a horizontal surface and a mount system useful for positioning a display on a generally vertical surface. As shown in FIGS. 7(a) and 7(b), in some embodiments, the invention includes a convertible mounting system 11 that provides a simple and cost-effective configuration including a first mount portion 41 and a second mount portion 42. In some embodiments, as shown in FIGS. 7(a) and 7(b), the first mount portion 41 includes a bracket adapted to couple with the second mount portion 42, which in this embodiment takes the form of a post. In some embodiments, as shown in FIG. 7(a), the first mount portion 41 cooperates with the second mount portion 42 in a first orientation to position a flat panel display 20 on a generally horizontal surface. As shown in FIG. 7(b), the first mount portion 41 also cooperates with the second mount portion 42 in a second orientation to position the flat panel display on a generally vertical surface. In certain embodiments, the second mount portion 42 has an alignment in the first orientation with respect to the first mount portion 41 that is generally orthogonal to the alignment of the second mount portion 42 in the second orientation with respect to the first mount portion 41. This relative orthogonal relationship is useful for converting between orthogonal surfaces, such as a generally vertical surface and a generally horizontal surface.

In some embodiments, as shown in FIGS. 7(a) and 7(b), the first mount portion 41 includes a first mount first engaging member 43 (for example, a hook) and a first mount second engaging member 44 (for example, a set of side flaps having holes therein). The second mount portion 42 can include corresponding second mount first engaging members 45a and 45b (for example, internally-threaded screw holes 45a and an opening 46b). As shown in FIG. 7(b), the second mount portion 42 also includes corresponding second mount second engaging members 46a and 46b (for example, internally-threaded screw holes 46a and an opening 46b) that are positioned to facilitate mounting the display 20 in the second orientation on a generally vertical surface.

The first mount engaging members 43, 44 are engageable with the second mount first engaging members 45a, 45b to provide a mounting system to position a flat panel display on a generally horizontal surface. For example, in the embodiment shown in FIG. 7(a), the first mount portion 41 can be attached to the second mount portion 42 with its hook 43 received in the opening 45b in the end of the second mount portion. The side flaps 44a can be coupled about the second mount portion with fasteners (e.g., bolts, screws, nails) that are received within the holes 45a in the side of the second mount portion 42. The first mount engaging members 43, 44 are also engageable with the second mount second engaging members 46a, 46b in a similar manner to provide a mounting system to position the flat panel display on a generally vertical surface. The second mount first engaging member 45b may be positioned orthogonal to the second mount second engaging member 46b (e.g., the hook openings) to allow rotation of the second mount portion 42 into its second orientation shown in FIG. 7(b), which is orthogonal to its first orientation shown in FIG. 7(a). In some embodiments, the first mount portion 41 is connected to the flat panel display 20 and the second mount portion 42 is connected to a base 81. In some embodiments, an opposite arrangement can also be used in which the first mount portion 41 is coupled to the base 81 and the second mount portion is coupled to the display 20. The first or second mount portions 41, 42 can be integrally formed with the display or base, or alternately coupled to the display or base with a fastening mechanism. For example, as shown in FIGS. 7(a) and 7(b), fasteners 47 couple the first mount portion 41 with the display. The first mount portion may in some cases have an integral monitor mounting plate (not shown) adapted to couple to the display 20. In some embodiments a connection mechanism 48 couples the base 81 with the second mount portion 42. The connection mechanism 48 can incorporate a variety of connections, and may be a fixed connection or alternately provide swivel, rotation, and/or tilt capabilities. Fasteners 49 (e.g., screws, nails, bolts, etc.) can couple the base 81 to a generally vertical surface in the second orientation.

Of course, FIGS. 7(a) and 7(b) depict only one of several possible embodiments incorporating a simple and cost-effective mounting configuration, and the scope of the invention is not limited to the particular embodiment shown. The first and the second mount portions may have a variety of configurations that also allow for configuring the mount portions in the first and the second orientations shown in FIGS. 7(a) and 7(b). Further, the first mount portion 41 and the second mount portion 42 can comprise any suitable material, including metals, alloys, and/or polymers known in the art.

Returning to FIG. 5(a), in some embodiments, the first mount portion 30 is adapted to connect to a flat panel display. In such embodiments, the first mount portion can include a monitor mounting plate 90 adapted to couple the first mount portion to a display. The mounting plates can take any suitable form. In some embodiments, the mounting plates engage against the flat panel display to couple the mount to the display. The mounting plates couple with the display with any suitable coupler such as bolts, bosses, adhesives or the like.

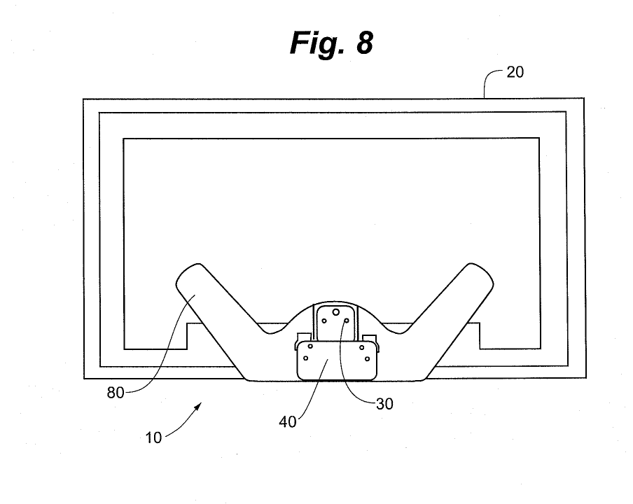

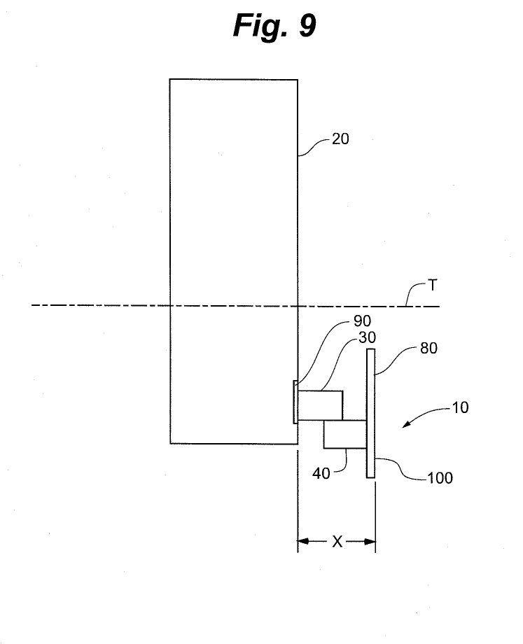

Further, the first mount portion can be attached to the flat panel display at any suitable location. For example, the monitor may be mounted to the standard VESA connection provided in the rear of a flat panel display. Such connections are usually proximate the center of gravity of the display and are generally located in the center of the display. In other embodiments, the first mount portion attaches to the display via the monitor mounting plate on the bottom third of the monitor as shown in FIG. 8 (e.g., below line T in FIG. 9). Such a mounting location allows for a tilting mount that is lower profile than connecting at the standard VESA location. For example, such a profile can be reduced from about 3-4 inches to less than about 2 inches (e.g., about 1 inch). As shown in FIG. 9, in some embodiments a horizontal distance “X” from the monitor mounting plate to the opposite edge of the first mount portion and second mount portion body is less than about two inches.

Some embodiments of the convertible mounting system 10 further include a base 80 coupled to the second mount portion 40. Such a base is useful for resting against a generally horizontal surface and for direct attachment to a generally vertical surface. In certain embodiments, the base defines a generally planar base surface 100 useful for placement on the generally horizontal surface when the rigid protrusion is received within the first protrusion receiving aperture, as shown in FIG. 3. The base also defines a generally planar vertical base surface useful for placement on the generally vertical surface when the rigid protrusion is received within the second protrusion receiving aperture, as shown in FIG. 4.

In some embodiments, as shown in FIG. 6(b), the base 80 defines mounting apertures 110 to rigidly secure the second mount portion to the generally vertical surface with a fastener (e.g., screws). In certain embodiments, the mounting apertures are placed to correspond with common wall stud spacing to facilitating mounting to a vertical surface. For example, in some embodiments at least some of the mounting apertures are spaced about 16 inches on center to align with common residential wall stud spacing in the United States. In some embodiments, as shown in FIGS. 6(c) and (d), a cover plate 120 overlaying the base is provided. Such a cover plate is useful for keeping the convertible mounting system aesthetically pleasing as it covers up mounting apertures and fasteners when the system is mounted to a generally vertical surface.

Some embodiments of the convertible mounting system 10 allow the flat panel display 20 to be repositioned to adjust for glare or optimal viewing from multiple locations when configured to position the display on a horizontal surface and provide for a low profile mount when configured to position the display on a vertical surface. For example, degrees of motion of tilt, pan, and/or lift motion can be provided. In some embodiments, the convertible mounting system 10 provides the same movement characteristics (e.g., force profile required to move the flat panel display) regardless of whether the mounting system is in the first orientation for positioning a flat panel display on a generally horizontal surface or the second orientation for positioning a flat panel display on a generally vertical surface.

In some embodiments, the convertible mounting system 10 includes a tilt system that allows the flat panel display to be tilted relative to the base in the first and/or second orientations. The tilt can be provided by any suitable tilt system. For example, the tilt system can include a friction tilt mechanism or a torsion spring assisted tilt mechanism (for example, as described in Applicant's own U.S. Pat. No. 7,252,277, the relevant contents of which are hereby incorporated by reference). In some embodiments, the tilt system includes a gravity pivot system (for example, as described in Applicant's own US Patent Publication No. 2006/0226326, the relevant contents of which are hereby incorporated by reference). Such embodiments allow the tilt mechanism to be located below and behind the center of gravity of the display instead of being located at the same vertical location as the display's vertical center of gravity.

In some embodiments of the gravity pivot system, as shown best in FIG. 5(a), the first mount portion 30 comprises and/or cooperates with a first engaging member 130, a first surface 140 to engage the first engaging member, a second engaging member 150, and a second surface 160 to engage the second engaging member. The first and second engaging members 130, 150 may be coupled to the monitor mounting plate 90, such as by insertion through monitor mounting plate aperture sets 164, 166 defined by panels 168. In some embodiments the first and second surfaces cooperate with the first and second engaging members to continuously immobilize the display at any angle within the range of angles allowed by the mount to provide for tilt adjustment of the display when the mounting system is configured to position the display on the generally horizontal surface or to position the display on a generally vertical surface.

In some embodiments, the first surface 140 and second surface 160 cooperate to allow the display position to be easily adjusted and to continuously immobilize the display when adjustment is not desired. Continuous immobilization allows for the display to be positioned and secured at any angle within the range of angles allowed by the mount. Generally, the surfaces cooperate to balance the changing moments created by the changing center of gravity position of the display as it is moved. For example, the shape of the first and second surfaces may cooperate so that the sum of the moments about the mount remains zero, regardless of the position of the display within the range of angles allowed by the mount. The first and second surfaces may be provided in any suitable form or configuration to provide this result. For example, one or more of the surfaces can be provided within a slot 170, as shown in FIGS. 5(b) and (c). Further, one or more of the surfaces may be an existing structure, such as a wall or floor. In addition, one or more of the surfaces may be carried by the display itself.

Any amount of tilt can be provided. For example, plus or minus about 15 degrees deflection from vertical. The range of adjustment may be limited by the range of the tilt system itself, or by the manual placement of tilt stops (e.g., screws or interfering brackets) to restrict motion. Further, as shown best in FIG. 5(a), an actuator 174 (e.g., knob) can be provided to allow a user to lock the tilt position of the display relative to the mount. When desired, a user can actuate the actuator (e.g., rotate the knob about its rotational axis) to increase frictional forces and thereby “lock” the tilt position of the display relative to the mount. Of course, the actuator may also be used to unlock the tilt position of the display relative to the mount.

In some embodiments, the amount of tilt provided can be dependent upon whether the mounting system is configured to position a flat panel display on a generally vertical surface or a generally horizontal surface. For example, in the generally horizontal configuration, about −15 to about +5 degrees of tilt may be desired. In the vertical configuration, about +5 to about −15 degrees of tilt may be desired. Accordingly, some embodiments of the invention allow for the range of motion to be different depending on the orientation of the mounting system. Accordingly, in some embodiments, the manually placed tilt stops may be placed at different locations within the tilt system, as desired, depending on the orientation of the convertible mounting system.

As an example of a convertible mounting system 10 adapted to allow for panning of the display relative to the base, embodiments having a first mount engaging member 50 (e.g., rigid protrusion) mating with the first and second second mount engaging members (e.g., receiving apertures) allow for panning of the flat panel display relative to a generally horizontal surface or a generally vertical surface. For example, the rigid protrusion member may have a generally cylindrical shape and be received within a generally cylindrical aperture. Such a shape allows the rigid protrusion to articulate within the receiving aperture. If desired, pan stops (e.g., posts and/or slots) may be provided on or in the projection or corresponding receiving aperture to limit the range of pan. Further, such pan stops may be selectively engageable and/or adjustable such that more panning is permitted when the convertible mounting system is configured to position a display on a generally horizontal surface and relatively less panning is permitted with the convertible mounting system is configured to position a display on a generally vertical surface. As another example, pan may be provided by including two parallel plates coupled by a friction joint within the convertible mounting system, one of the plates being associated with the display and the other plate associated with the base. Such parallel plates allow for relative motion between them to provide for panning of the display relative to the base.

Regarding a convertible mounting system with lift, any lift system can be utilized to provide this degree of motion. For example, in embodiments having a base and a second mount portion, the second mount portion could include a generally vertical member having a lift mechanism, such as a gas spring or a rotary cam lift mechanism (for example, as described in Applicant's own US Patent Publication No. 2006/0185563, the relevant contents of which are hereby incorporated by reference), to allow for vertical motion of the display relative to the base. Such vertical motion can be provided when the base is orientated to sit against a generally horizontal surface or a generally vertical surface.

Embodiments of the invention also include a method of converting a flat panel display mounting system, including any of the embodiments of convertible mounting systems 10 described herein. For example, the method can include the steps of converting a mounting system from a first orientation suitable for positioning a flat panel display of a generally horizontal surface to a second orientation suitable for positioning a flat panel display on a generally vertical surface.

For example, in some embodiments, the method includes the steps of removing (e.g., lifting) a rigid protrusion of a first mount portion from a first protrusion aperture defined by a second mount portion body, the display mounting system being in a first configuration to position the display on a generally horizontal surface and inserting the rigid protrusion into a second protrusion receiving aperture defined by the second mount portion body, the second protrusion receiving aperture being generally orthogonal to the first protrusion receiving aperture, to place the mounting system in a second configuration to position the display on a generally vertical surface.

In some embodiments, the method further includes the step of attaching a base that defines a generally planar vertical base surface to the generally vertical surface. Further, in certain embodiments, the method includes the step of placing a cover plate over the base after attaching the base to the generally vertical surface and before the rigid protrusion is inserted into the second protrusion receiving aperture.

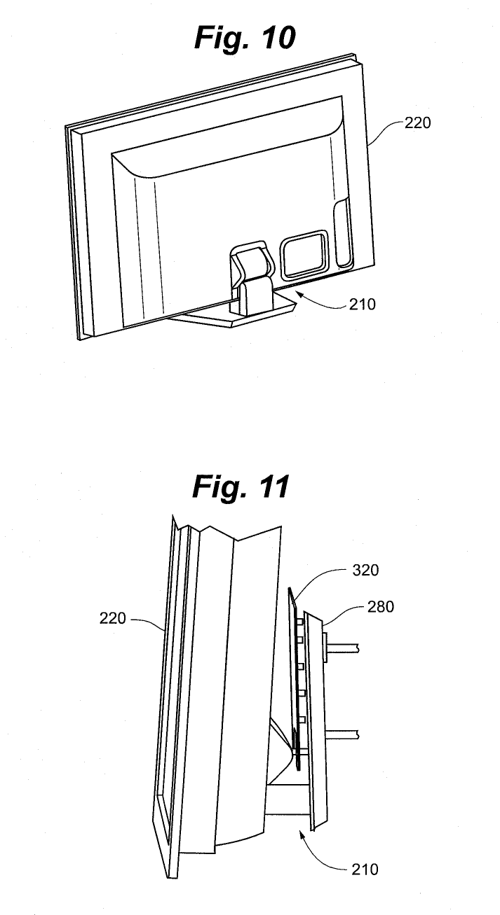

FIGS. 10 and 11 show perspective views of a flat panel display and a convertible mounting system in a first orientation and a second orientation, respectively. The convertible mounting system 210 operates to position a flat panel display 220 on a generally horizontal surface (e.g., desk top, table, floor, ceiling, desk mount via clamp or grommet mounting, etc.) or a generally vertical surface (e.g., wall, wall track mount, pole, column, etc.). The flat panel display 220 includes, but is not limited to, a plasma display, liquid crystal display (LCD), organic light-emitting diode (OLED), or the like. The convertible mounting system 210 may accommodate a wide variety of display sizes and weights.

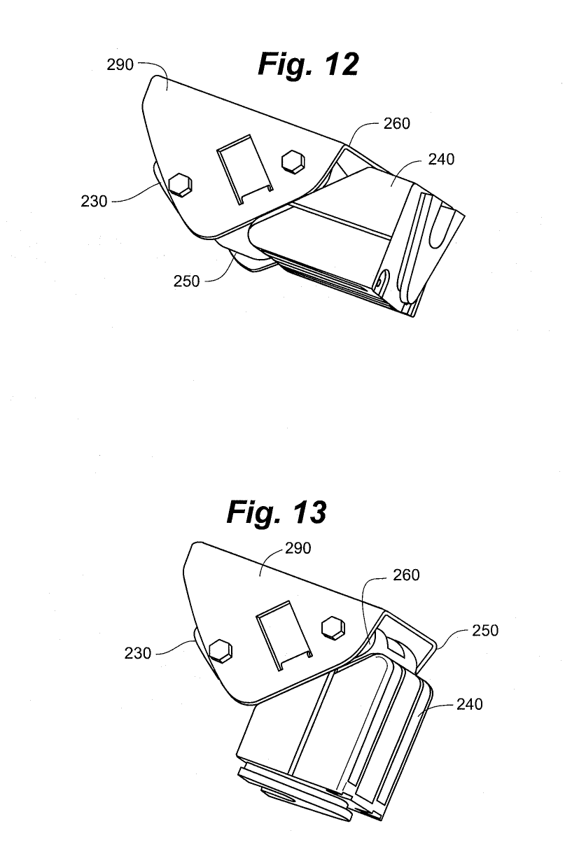

In some embodiments, the invention includes a convertible mounting system 210 for a flat panel display 220. As shown in FIG. 12, the convertible mounting system 210 can include a first mount portion 230 and a second mount portion 240. In some embodiments, as shown in FIGS. 10 and 12, the first mount portion 230 cooperates with the second mount portion 240 in a first orientation to position a flat panel display 220 on a generally horizontal surface. As shown in FIGS. 11 and 13, the first mount portion also cooperates with the second mount portion in a second orientation to position the flat panel display on a generally vertical surface. In certain embodiments, the first mount portion 230 is rotated approximately 180 degrees with respect to the second mount portion 240 in the first orientation with respect to the second orientation. This rotational relationship is useful for converting between orthogonal surfaces, such as a generally vertical surface and a generally horizontal surface. In certain embodiments, the second mount portion 240 has an alignment in the first orientation with respect to the first mount portion 230 that is generally orthogonal to the alignment of the second mount portion 240 in the second orientation with respect to the first mount portion 230. This relative orthogonal relationship is useful for converting between orthogonal surfaces, such as a generally vertical surface and a generally horizontal surface.

The first and second mount portions can include any structure useful for allowing conversion between a mount useful for positioning a display on a horizontal surface and a mount system useful for positioning a display on a generally vertical surface. In some embodiments, as shown in FIGS. 12-14, the first mount portion includes a first mount engaging surface 250 and the second mount portion can include a second mount engaging surface 260 generally adjacent the first mount engaging surface 250. The first mount engaging surface 250 can be rotatably engaged with the second mount engaging surface 260 to provide a mounting system that can position a flat panel display on a generally horizontal surface in a first orientation and on a generally vertical surface in a second orientation.

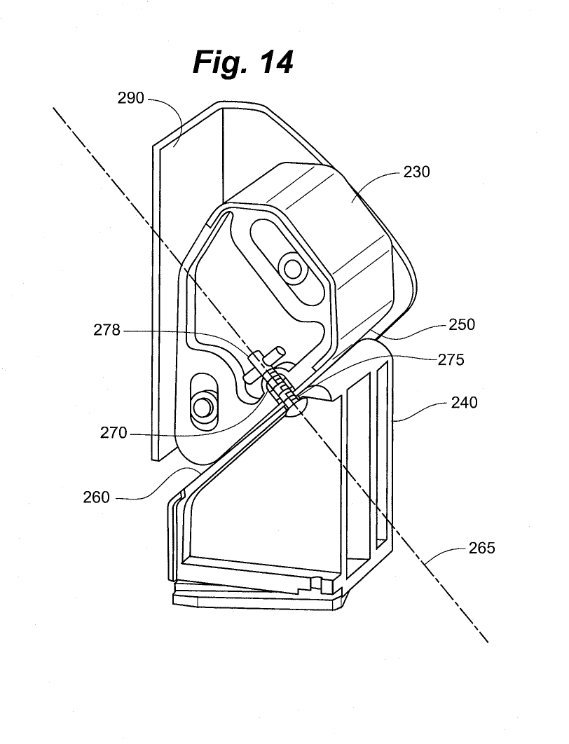

In some embodiments the first mount portion 230 is rotated approximately 180 degrees with respect to the second mount portion 240 to convert the mounting system from the first orientation to the second orientation. For example, as shown in FIG. 14, in some cases the first mount portion 230 and the second mount portion 240 rotate about an axis of rotation 265 that is about 45 degrees from the generally horizontal surface in the first orientation of the mounting system. As shown in FIGS. 12 and 13, in some cases the first mount portion 230 is generally orthogonal to the second mount portion 240 in the first orientation with respect to the second orientation.

The first and the second mount engaging surfaces can include any structure useful for rotatably engaging the mount portions and surfaces for positioning a display on a horizontal surface and a mount system useful for positioning a display on a generally vertical surface. As shown in FIG. 14, in some embodiments the first mount engaging surface 250 defines a first aperture 270 and the second mount engaging surface 260 defines a second aperture 275 for engaging with the first aperture. In some cases a fastening member 278 (e.g., bolt, screw, rivet, boss, etc.) is received within the first aperture and the second aperture to rotatably couple or engage the first mount engaging surface and the second mount engaging surface. For example, the fastening member 278 can extend generally along the axis of rotation 265 to rotatably couple the first and the second mount portions at the first and the second mount engaging surfaces.

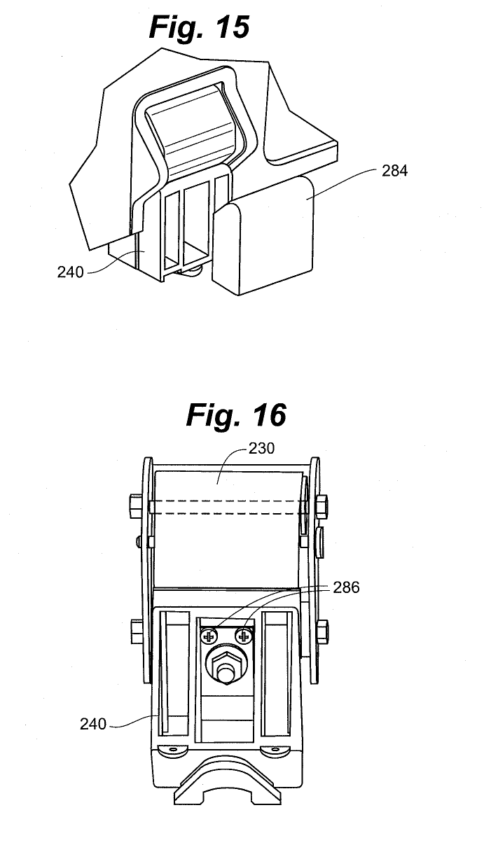

Turning to FIGS. 15 and 16, in some embodiments the first and/or the second mount portions are provided with a removable cover. As shown in FIG. 15, the second mount portion 240 can include a removable cover 284, which when disassembled from the second mount portion provides access to an inside of the second mount portion. In some embodiments the first and the second engaging surfaces define locking apertures (not shown) that are adapted to receive one or more locking members 286. Inserting the locking members 286 through the locking apertures can immobilize the first and the second engaging surfaces, thus disabling relative rotational movement between the first and the second engaging surfaces and mount portions. The locking members 286 can be temporarily removed to allow rotation of the first and second mount portions from the first orientation to the second orientation. Once rotated to the second orientation, the locking members 286 can again be inserted into the locking apertures to disable rotational movement between the first and the second mount portions.

As discussed above, some embodiments of a convertible mounting system 210 allow the flat panel display 220 to be repositioned by providing degrees of tilt, pan, and/or lift. Regarding a convertible mounting system with lift, any lift system (such as those described above) can be utilized to provide this degree of motion. In some embodiments, the convertible mounting system 210 includes a tilt system that allows the flat panel display to be tilted relative to the base in the first and/or second orientations. The tilt can be provided by any suitable tilt system, such as those described above. In some embodiments, the tilt system includes a gravity pivot system such as one of the gravity pivot systems described above.

In some embodiments, the convertible mounting system 210 provides the same movement characteristics (e.g., force profile required to move the flat panel display) regardless of whether the mounting system is in the first orientation for positioning a flat panel display on a generally horizontal surface or the second orientation for positioning a flat panel display on a generally vertical surface. In some embodiments, the amount of tilt provided can be dependent upon whether the mounting system is configured to position a flat panel display on a generally vertical surface or a generally horizontal surface. For example, in the generally horizontal configuration, about −15 to about +5 degrees of tilt may be desired. In the vertical configuration, about +5 to about −15 degrees of tilt may be desired. Accordingly, some embodiments of the invention allow for the range of motion to be different depending on the orientation of the mounting system.

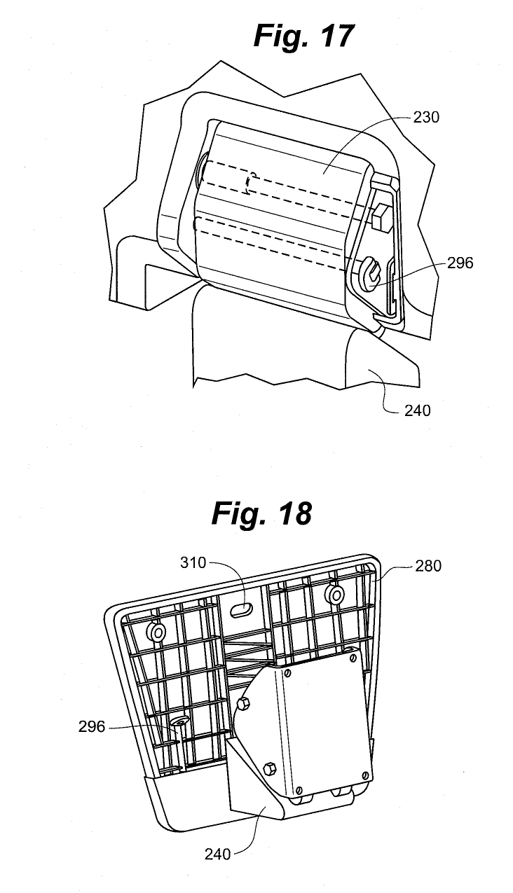

In some embodiments it may be desirable to limit or even completely restrict tilt adjustment of the display. As shown in FIG. 17, in some embodiments a tilt stop 296 is adapted to be received within the tilt system to restrict or disable the tilt mechanism. In some embodiments the tilt adjustment may only be disabled in the first orientation, such that the display cannot be tilted when it is being supported by a generally horizontal surface. Such a configuration can allow bases with a smaller configuration. In some embodiments the tilt adjustment may then be provided in the second orientation when the display is supported by a generally vertical surface. When not in use, the tilt stop 296 can in some cases be stored within the base 280 as shown in FIG. 18.

The first mount portion 230 or the second mount portion 240 can be connected to a flat panel display 220 or a base 280, as discussed with respect to the embodiments discussed above. In some embodiments, the first mount portion 230 is adapted to connect to a flat panel display. As shown in FIG. 14, in such embodiments the first mount portion can include a monitor mounting plate 290 adapted to couple the first mount portion to a display. The mounting plates can take any suitable form. In some embodiments, the mounting plates engage against the flat panel display to couple the mount to the display. The mounting plates couple with the display with any suitable coupler such as bolts, bosses, adhesives or the like. Further, the first mount portion 230 can be attached to the flat panel display at any suitable location, as discussed above.

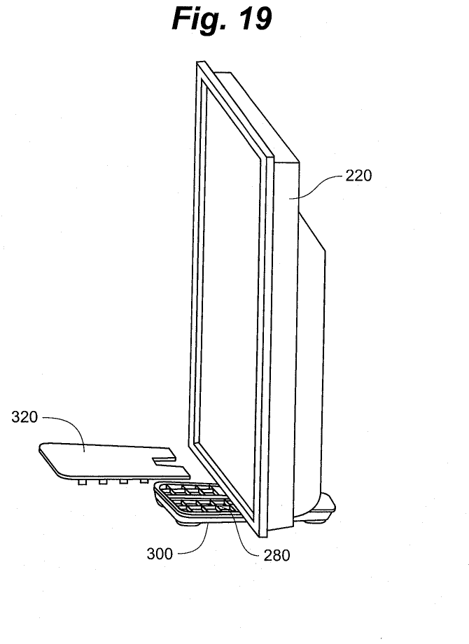

Turning to FIG. 19, some embodiments of the convertible mounting system 210 further include a base 280 coupled to the second mount portion 240. Such a base is useful for resting against a generally horizontal surface and for direct attachment to a generally vertical surface. In certain embodiments, the base defines a generally planar base surface 300 useful for placement on the generally horizontal surface when the first and second mount portions are in the first orientation, as shown in FIG. 10. The base also defines a generally planar vertical base surface useful for placement on the generally vertical surface when the first and the second mount portions are in the second orientation, as shown in FIG. 11.

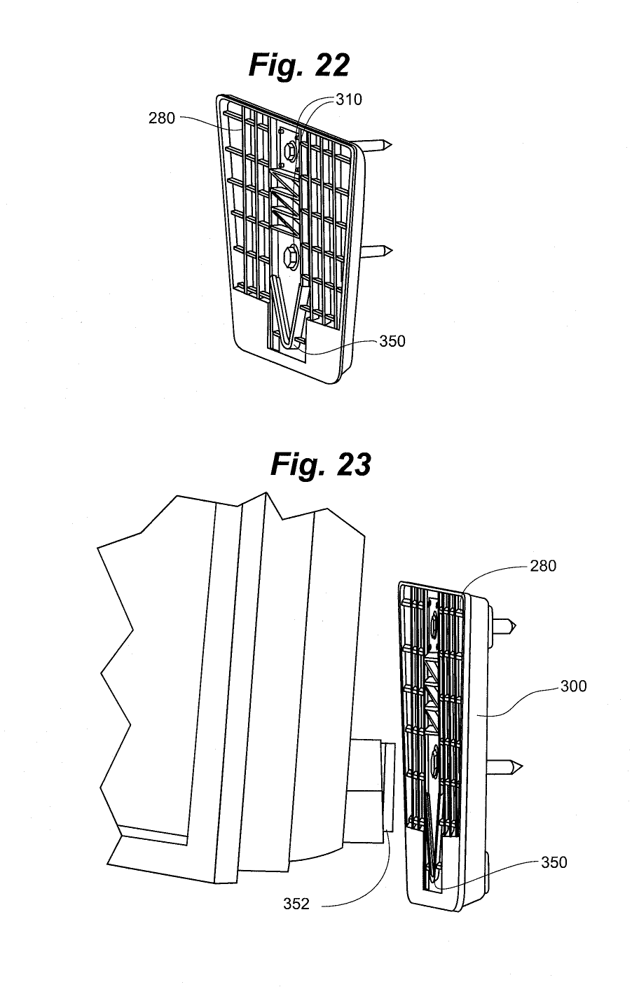

In some embodiments, as shown in FIGS. 18 and 22, the base 280 defines mounting apertures 310 to rigidly secure the second mount portion to the generally vertical surface with one or more fasteners (e.g., screws). In some embodiments, as shown in FIGS. 11 and 19, a cover plate 320 overlaying the base is provided. Such a cover plate is useful for keeping the convertible mounting system aesthetically pleasing as it covers up mounting apertures and fasteners when the system is mounted to a generally vertical surface or when the system is resting upon a generally horizontal surface.

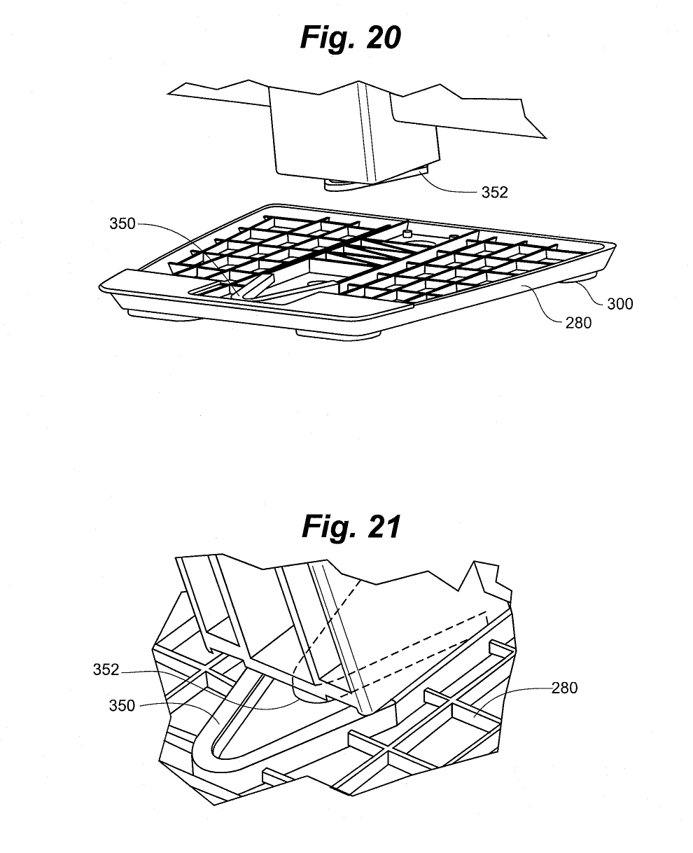

As shown in FIGS. 20 and 21, in some embodiments the base 280 includes an attachment structure for fastening the base with the second mount portion 240 in the first and/or the second orientation. For example, in some embodiments the base 280 is provided with an attachment seat 350 that is adapted to receive an attachment member 352 coupled or integral with the second mount portion 240. The attachment seat 350 and the attachment member 352 can be provided with any suitable configuration. As shown in FIG. 21, in some embodiments the attachment seat and attachment member are configured in cooperating “dovetail” or “horseshoe” patterns. These designs can provide easy alignment and a robust joint when seated.

Embodiments of the invention also include a method of converting a flat panel display mounting system, including any of the embodiments of convertible mounting systems described herein. For example, the method can include the steps of converting the mounting system 210 from a first orientation suitable for positioning a flat panel display of a generally horizontal surface to a second orientation suitable for positioning a flat panel display on a generally vertical surface.

In some embodiments the method includes rotating a first mount portion approximately 180 degrees with respect to a second mount portion, from a first orientation for positioning the display on a generally horizontal surface to a second orientation for positioning the display on a generally vertical surface. In some embodiments, the method further includes the step of attaching a base that defines a generally planar vertical base surface to the generally vertical surface. Further, in certain embodiments, the method includes the step of placing a cover plate over the base after attaching the base to the generally vertical surface.

Accordingly, embodiments of the convertible mounting system allow for a cost-effective mount that is can be used in a configuration desired by a user. Further, although not limited to such, the mount may be optionally customized to a particular flat panel display and delivered in combination to a user. Such a system allows for better performing mounting systems as compared to after market mounts that must work with a variety of displays. Of course, the embodiments of convertible mounting systems described herein may also be supplied as an after market mounting system. Further, embodiments of convertible mounting systems described herein allow a consumer to use a single mount in either a horizontal or vertical configuration with a minimum of waste as the same parts are used in both configurations. Such a system also allows a consumer to quickly and easily change orientations of a display over time without having to keep two or more separate mounts on hand.

Although selected advantages are detailed above, the list is not intended to be exhaustive. Although specific examples have been illustrated and described herein, it will be appreciated by those of ordinary skill in the art that any arrangement which is calculated to achieve the same purpose may be substituted for the specific embodiment shown. This application is intended to cover any adaptations or variations of the invention. It is to be understood that the above description is intended to be illustrative, and not restrictive. Combinations of the above embodiments and other embodiments will be apparent to those of skill in the art upon reviewing the above description. The scope of the invention includes any other applications in which the above structures and fabrication methods are used.

What is claimed is:

1. A convertible mounting system for a flat panel display, comprising:
a first mount portion integral with or adapted to couple to the flat panel display; and
a second mount portion integral with or adapted to couple with a base, the first mount portion cooperating with the second mount portion in a first orientation to position the flat panel display on a generally horizontal surface, and the first mount portion cooperating with the second mount portion in a second orientation to position the flat panel display on a generally vertical surface, a first alignment of the second mount portion in the first orientation being generally orthogonal to a second alignment of the second mount portion in the second orientation.

2. The convertible mounting system of claim 1, wherein the first and the second mount portions are removably coupled.

3. The convertible mounting system of claim 1, wherein the first and the second mount portions are rotatably engaged.

4. A convertible mounting system for a flat panel display, comprising:
a first mount portion; and
a second mount portion, the first mount portion rotatably engaged with the second mount portion to provide a mounting system to position a flat panel display on a generally horizontal surface in a first orientation and to position the flat panel display on a generally vertical surface in a second orientation.

5. The convertible mounting system of claim 4, wherein the first mount portion is rotated approximately 180 degrees with respect to the second mount portion in the first orientation with respect to the second orientation.

6. The convertible mounting system of claim 5, wherein the first mount portion includes a monitor mounting plate adapted to couple the first mount portion to a display and a first alignment of the second mount portion in the first orientation is generally orthogonal to a second alignment of the second mount portion in the second orientation.

7. The convertible mounting system of claim 5, wherein the first mount portion includes a monitor mounting plate adapted to couple the first mount portion to a display and a first mount engaging surface defining a first aperture, the second mount portion includes a second mount engaging surface defining a second aperture, and further comprising a fastening member received within the first aperture and the second aperture for rotatably engaging the first mount portion and the second mount portion.

8. The convertible mounting system of claim 5, wherein the first mount portion and the second mount portion rotate about an axis of rotation that is about 45 degrees from the generally horizontal surface in the first orientation of the mounting system.

9. The convertible mounting system of claim 5, wherein the first and the second mount portions define locking apertures to disable relative rotational movement between the first and the second mount portions.

10. The convertible mounting system of claim 5, wherein the first mount portion includes a monitor mounting plate adapted to couple the first mount portion to a display and a gravity pivot system.

11. The convertible mounting system of claim 10, wherein the first mount portion comprises:
a first engaging member carried by the monitor mounting plate;
a first surface to engage the first engaging member;
a second engaging member carried by the monitor mounting plate; and
a second surface to engage the second engaging member, the first and second surfaces cooperating with the first and second engaging members to continuously immobilize the display at any angle within a range of angles allowed by the mounting system to provide for tilt adjustment of the display.

12. The convertible mounting system of claim 5, wherein the first mount portion allows for tilt adjustment of the display relative to the second mount portion.

13. The convertible mounting system of claim 12, further comprising a tilt stop adapted to restrict the tilt adjustment of the display.

14. The convertible mounting system of claim 5, further including a flat panel display, the first mount portion being attached to the display via a monitor mounting plate on the bottom third of the display.

15. The convertible mounting system of claim 5, further including a base coupled to the second mount portion.

16. The convertible mounting system of claim 15, wherein the base defines a generally planar base surface useful for placement on the generally horizontal surface when the mounting system is rotatably engaged in the first orientation and useful for placement on the generally vertical surface when the mounting system is rotatably engaged in the second orientation.

17. The convertible mounting system of claim 15, wherein the base defines mounting apertures to rigidly secure the second mount portion to the generally vertical surface.

18. A method of converting a flat panel display mounting system, the method comprising rotating a first mount portion approximately 180 degrees with respect to a second mount portion, from a first orientation for positioning the display on a generally horizontal surface to a second orientation for positioning the display on a generally vertical surface.

19. The method of claim 18, further comprising attaching a base that defines a generally planar vertical base surface to the generally vertical surface.

20. The method of claim 19, further comprising placing a cover plate over the base after attaching the base to the generally vertical surface.
